(19) United States
(12) Patent Application Publication
(10) Pub. No.: US 2022/0056304 A1
(43) Pub. Date: Feb. 24, 2022

(54) METALLIC PAINTS WITH HIGH HIDING POWER AND ORGANIC BINDER RESIN FOR THESE PAINTS

(71) Applicant: Arkema France, Colombes (FR)

(72) Inventors: Gregory DELMAS, Verneuil En Halatte (FR); Justine Lassalle, Verneuil En Halatte (FR); Didier Evrard, Verneuil En Halatte (FR)

(21) Appl. No.: 17/312,457

(22) PCT Filed: Dec. 12, 2019
(86) PCT No.: PCT/EP2019/084810

§ 371 Date: Jun. 10, 2021

(30) Foreign Application Priority Data
Dec. 13, 2018 (FR) 1872859

(51) Int. Cl. C09D 133/04; C09D 5/02; C09D 7/61; C09D 7/40

(52) U.S. Cl. CPC C09D 133/04; C09D 7/70; C09D 7/61; C09D 5/02

(57) ABSTRACT

The invention relates to organic binder resins for aqueous coatings, comprising: a) a polymer P1, bearing reactive groups X1: hydroxyl and Y1: carboxyl with an OH number as a weight percentage of OH ranging from 2% to 5% and an acid number IA mg KOH/g of at least 10, said polymer P1 having a mass Mn1 of less than 25 000, and b) a polymer P2 bearing reactive groups X2: hydroxyl with an OH number as a weight percentage of OH ranging from 0.5% to 2.5%, groups Y2: carboxyl with an acid number IA in mg KOH/g<25, and groups Z2 chosen from acetoxy and/or diacetone and said polymer P2 having a mass Mn2 of greater than 500,000.

The invention also relates to a process for preparing said resin, to a metallic coating composition comprising said resin and metallic pigment, and to the use thereof.

The present invention relates firstly to an organic binder resin based on a mixture of two polymers respectively having specific functionalities and molecular masses, to a process for preparing said resin and to the uses thereof in metallic coating compositions, in particular water-based metallic paints and to metallic coating compositions comprising said resin and having high masking power by means of correct orientation of the metallic pigments.

In order to obtain a metallic appearance, certain substrates are coated with a paint containing pigments/flakes of metals such as aluminum, copper, etc. These coatings may be in solvent phase or in aqueous phase. However, in order to reduce the environmental impact and to reduce the emissions of volatile organic compounds (VOCs), new paints are mainly developed in aqueous medium. The problem of metallized paints of this type is the placing of the metallic flakes in the paint film so as to obtain the desired esthetic appearance with, at the same time, high masking power and high gloss. Specifically, for a given flake concentration, the paint must completely mask and cover the substrate. Thus, the masking power of a paint is defined by the difference in color of this paint applied to a black and white background. An optical measurement taken with a colorimeter enables this masking power to be characterized (standard ISO 6504). According to the invention, the term “high masking power” in particular means a masking power value according to the method (standard) ISO 6504 of greater than 98%. According to the invention, the term “high gloss” in particular means a gloss value in gloss units (gu) according to the method (standard) ISO 2813 of greater than 65 for a measurement angle of 60°.

In metallic paints in aqueous medium, there is a need for water-dispersible organic binder resins which form a stable dispersion and which have a specific affinity for metallic pigments, in particular for metallic pigments in the form of flakes, such as aluminum or copper pigments. The masking power of the paint is thus linked to the ability of the organic binder resin to undergo film formation as a homogeneous film while at the same time allowing fine dispersion of the metallic pigment particles (flakes) and their orientation in the homogeneous film obtained with high masking power of the paint and simultaneously high gloss.

The present invention relates firstly to an organic binder resin which is a mixture of two polymeric resins:
P1 which is an acrylic polymer resin functionalized with —OH and —CO₂H with a number-average molecular mass Mn, measured by GPC in THE with polystyrene calibration, Mn<25 000, preferably from 2000 to 15 000, and dispersible in water without any surfactant or dispersant, and
P2 which is an acrylic polymer resin functionalized with acetoxy and/or diacetone in addition to the OH and —CO₂H groups and which has an Mn>500 000,
   with the mixture P1+P2 having a synergistic effect in application performance and in particular relative to the masking power of the metallic coating, relative to the effects of each of the two resins taken separately.

As regards the masking power of the final composition of this coating, for a dry thickness of 10 to 25 μm, an increase of at least 2% (visible to the eye) and preferably from 2% to 15% is obtained in the masking power (according to the standard ISO 6504) obtained with a coating composition comprising said resin of the invention with P1+P2 relative to a P2-free resin (P2-free resin taken as comparative reference). At the same time, the gloss at an angle of 60° of said coating is also significantly improved by at least 15%, preferably at least 20%.

Another subject of the invention relates to a process for preparing said organic binder resin according to the invention, comprising the preparation in separate steps of, respectively, each of said polymers P1 and P2 in the form of an aqueous dispersion and, to finish, the mixing of two corresponding aqueous dispersions.

Another subject of the invention relates to a coating composition which comprises at least one organic binder resin according to the invention, this composition more particularly being a metallic coating composition also comprising a metallic pigment.

The invention also covers the use of said organic binder resin in metallic coating compositions having crosslinking behavior of one-component type or of two-component type and having more homogeneous dispersion of the metallic pigments and masking power measured according to the method ISO 6504 which is higher than that of the composition not comprising the polymeric resin P2.

Finally, the invention covers the finished product which is a metallic coating resulting from said organic binder resin or from said coating composition as defined above according to the invention.

The first subject of the invention thus relates to an organic binder resin for aqueous coatings, which comprises:
a) a polymer P1, bearing reactive groups X1: hydroxyl and Y1: carboxyl with, respectively, an OH number expressed as weight percentage of OH ranging from 2% to 5%, preferably from 2% to 4%, and an acid number IA expressed in mg KOH/g of at least 10, preferably ranging from 10 to 50, more preferentially from 10 to 40, and said polymer P1 having a number-average molecular mass Mn1 (by GPC in THE with polystyrene calibration) of less than 25 000, preferably ranging from 2000 to 15 000, preferably ranging from 2000 to 10 000 and more preferentially from 3000 to 8000
b) a polymer P2 bearing reactive groups X2: hydroxyl with an OH number expressed as weight percentage of OH ranging from 0.5% to 2.5%, preferably from 0.5% to 2%, groups Y2: carboxyl corresponding to an acid number IA expressed in mg KOH/g<25, preferably less than 20, and groups Z2 chosen from acetoxy and/or diacetone and said polymer P2 having a number-average molecular mass Mn2 of greater than 500 000.

The molecular masses Mn1 for P1 are determined by GPC in THE with calibration using polystyrene standards. For Mn2, it may also be measured by GPC with polystyrene standards, but this molecular mass Mn2>500 000 is implicitly considered to be reached during emulsion radical polymerization without any transfer agent added.

According to a particular option of said resin, the weight ratio between the polymer P1 and the polymer P2, P1/P2, ranges from 50/50 to 95/5, preferably from 70/30 to 90/10 and more preferentially from 75/25 to 90/10.

According to a more particular and preferred option, said resin is in dispersion in water with a content of solids P1+P2 ranging from 30% to 60% and preferably from 35% to 55%.

According to another option, said polymer P2 comprises a crosslinking agent bearing at least two hydrazide groups, in particular when said polymer P2 is in the form of an aqueous polymer dispersion and more particularly an emulsion of said polymer. In this case, said polymer P2 and in particular said dispersion and more particularly said emulsion is self-crosslinkable by reaction of said hydrazide functions with said groups Z2 as defined above, after removal of the water by drying.

The polymers P1 and P2 are in the form of different particles. Thus, the polymer P1 is not copolymerized with the polymer P2. More particularly and preferably, said resin is in the form of a mixture of respective aqueous dispersions of the polymers P1 and P2.

According to a particular option of the resin of the invention, said polymer P1 is in the form of an aqueous dispersion without any surfactant or dispersant, preferably having a mean particle size ranging from 50 to 250 nm, preferably from 50 to 200 nm according to the method ISO 13320.

According to a particular option, said polymer P2 is in the form of an aqueous dispersion comprising at least one surfactant, preferably selected from surfactants simultaneously comprising a nonionic structure, in particular from alkoxylated, preferably ethoxylated, fatty alcohol residues and an anionic group, preferably from phosphates, phosphinate, sulfonate and sulfate.

According to another particular option of said resin according to the invention, said polymer P1 and said polymer P2 have respective glass transition temperatures Tg1 and Tg2, measured by DSC (10° C./min, two passes), as follows:
Tg1 less than or equal to 30° C., preferably from 0° C. to 30° C., even more preferentially from 10 to 30° C.
Tg2 greater than 30° C., preferably greater than 30° C. and ranging up to 65° C.

According to a particular option of the resin according to the invention, said polymer P1 and/or said polymer P2 are respective binary mixtures of two copolymers, one of which is more hydrophilic (or less hydrophobic). Even more particularly, the particles of two polymers P1 and/or P2 in aqueous dispersion are composed of two polymers, one of which is significantly more hydrophilic than the other, such that the less hydrophilic or the more hydrophobic positions itself at the core of the particle and the more hydrophilic around the less hydrophilic polymer. In this case, there is formation of a structured particle of polymer P1 and/or of polymer P2 as a core/shell. The hydrophilic (or less hydrophobic) polymer differs from the hydrophobic (or less hydrophilic) polymer by its significantly higher content of carboxylic acid monomer in the hydrophilic monomer with, in the hydrophobic polymer, a content of carboxylic acid monomer which is zero or at least several times smaller.

In general, a “hydrophobic” monomer is a monomer that has little affinity for water or that is sparingly soluble in water, the opposite being true for a hydrophilic monomer. The same principle applies to the polymers. One method for estimating this hydrophobicity is that of measuring the partition coefficient of the substance to be evaluated, between octanol and water, with the hydrophobicity expressed as a logarithm of this partition coefficient. The hydrophobicity value log Kow for a monomer is an estimation calculated from the logarithm of the partition coefficient (log P) between octanol and water, via the method of contribution of the atoms and the structural fragments of the molecule, using for this estimation the EPI (Estimation Program Interface) Suite© known as the KowWin software from SRC (Syracuse Research Corporation). The method and program epi V4.11 used for this calculation (estimation) of log Kow for the monomers are available at the address “https://www.epa.gov/tsca-screening-tools/download-epi-suitetm-estimation-program-interface-v411”. This methodology is described by W. M. Meylan and P. H. Howard in 1995 in Atom/fragment contribution method for estimating octanol-water partition coefficients in Pharm. Sci. 84: 83-92. The partition coefficient P corresponds to the ratio of the chemical concentration in the octanol phase relative to the chemical concentration in the aqueous phase in a system with two phases in equilibrium. As regards a copolymer, in particular such as P1 and P2 of the resin defined according to the invention, the overall hydrophobicity value according to the invention based on the logarithm of the octanol/water partition coefficient is defined as being the mean weight value relative to all of the component monomers of the resin and it is in particular estimated by the mean weight relative to all of the component monomers, from the individual log Kow values calculated via the KowWin method, as described above, and thus corresponds, according to this definition, to:

overall hydrophobicity value: Σi[xᵢ*(log Kow)ᵢ]

with
Σi: sum of i component monomers
xᵢ: weight fraction of the monomer i in said copolymer,
(log Kow)ᵢ: hydrophobicity value calculated by the KowWin method for said monomer i, with Kow corresponding to the calculated octanol/water partition coefficient and log Kow being the logarithm of this coefficient. These definitions thus make it possible to classify the polymers P1 and P2 according to their hydrophobic nature (according to increasing log Kow values): the more hydrophilic polymer is the one having the less hydrophobic nature (smaller log Kow value) and conversely (the more hydrophobic having the higher log Kow value).

More particularly, said polymer P1 is less hydrophobic (or more hydrophilic) than said polymer P2 with a log Kow value (P1) as defined above which is lower than the log Kow value (P2) corresponding to the polymer P2. Preferably, the difference between the two log Kow values is at least 0.5 and more particularly at least 1 unit.

According to a particular version of the resin according to the invention, said polymer P1 is in the form of a post-dispersion of said polymer after its preparation by solution radical polymerization in organic solvent medium, said polymer being dispersible in aqueous post-dispersion and not comprising any dispersant or surfactant. Even more particularly, said polymer P1 comprises an acrylic copolymer or a styrene-acrylic polymer. Thus, the polymer P1 may be prepared by solution radical polymerization in an organic solvent of alcoholic type such as butyl glycol, using an initiator of peroxide or perester type which is soluble in said solvent and with addition of the monomers in two steps: the first comprises the addition of the monomer composition corresponding to the hydrophobic polymer (absence of carboxylic acid monomer) and the second the monomer composition leading to the hydrophilic or less hydrophobic polymer (significant presence of carboxylic acid monomer). The content of polymer obtained in solution ranges from 75% to 90% by weight (equivalent to the starting content of monomers in solution). At the end of the polymerization, the final polymer in solution is neutralized (as regards the acid functions) with a base, which may be an amine, in particular a water-soluble tertiary amine with addition of water and dispersion in water by phase inversion with a final solids content adjusted within a range extending from 30% to 60% and preferably from 35% to 55% by weight.

The polymer P1 may in particular be a copolymer containing, as monomer units starting with a following overall monomer mixture:
a1) at least one C₂-C₄ hydroxyalkyl (meth)acrylate
a2) at least one C₁-C₂ alkyl methacrylate (without any functional group other than methacrylate)
a3) at least one C₄-C₈ alkyl acrylate (without any functional group other than acrylate)
a4) at least one C₁₀-C₁₄ alkyl (meth)acrylate monomer
a5) (meth)acrylic acid
a6) optionally, at least one vinylaromatic monomer.

As regards said polymer P2, it is in particular a copolymer in aqueous dispersion as obtained by emulsion polymerization with a solids content ranging from 30% to 60% and preferably from 35% to 55%.

More particularly, said polymer P2 may be a copolymer containing, as monomer units starting with a following overall monomer mixture:
b1) at least one C₂-C₄ hydroxyalkyl (meth)acrylate
b2) at least one C₁-C₂ alkyl methacrylate (without any functional group other than methacrylate)
b3) at least one C₄-C₈ alkyl methacrylate (without any functional group other than methacrylate)
b4) (meth)acrylic acid
b5) at least one from among the following monomers: diacetone acrylamide and/or (meth)acrylate bearing at least one acetoacetate group
b6) at least one di(meth)acrylate of a C₄-C₈ diol.

Said polymer P2 may be obtained by emulsion polymerization of a monomer composition corresponding to the monomer units and proportions in said polymer P2. The polymer particles P2 may be structured in core-shell form with a core polymer that is significantly less hydrophilic or more hydrophobic (with a zero content of carboxylic acid monomer) than the shell polymer which is significantly more hydrophilic or less hydrophobic with a significant content of carboxylic acid monomer. The difference in hydrophilicity is adjusted by the content of monomer acid and the incompatibility between the two polymers by two different glass transition temperatures of at least 30° C., preferably of at least 40° C.

A second subject of the invention relates to a process for preparing the resin according to the invention as defined above, which process comprises the following steps:
i) preparation of a polymer P1 as defined above according to the invention comprising a solution radical polymerization followed by post-emulsification in aqueous medium to give rise to an aqueous dispersion of said polymer P1,
ii) preparation by emulsion polymerization of an aqueous dispersion of polymer P2, as defined above according to the invention,
iii) mixing of said aqueous dispersion of said polymer P1 with that of said polymer P2.

Another subject of the invention relates to a coating composition which comprises at least one organic binder resin as defined above according to the invention.

In particular, said coating composition is a metallic coating composition and comprises, in addition to said organic binder resin (P1+P2), at least one metallic pigment, preferably with a content of said pigment relative to said dry organic binder (solids) ranging from 15% to 40% by weight, more preferentially ranging from 20% to 30% by weight. More particularly, said composition is an aqueous metallic coating composition with a content of solids P1+P2 ranging from 5% to 30%, preferably from 7% to 15%, relative to the weight of said composition. Preferably, said metallic pigment is selected from aluminum or copper pigments in the form of flakes. More preferentially, said coating composition is a metallic paint composition.

According to a more particular preference, said composition is an aqueous metallic paint with an aluminum pigment as metallic pigment.

According to a more particular option, said coating composition also comprises at least one crosslinking agent that is reactive with the hydroxyl groups of said polymer P1 and P2 and selected from melamines, polyisocyanates, in particular blocked polyisocyanates or carboxylic anhydrides, preferably melamines and polyisocyanates.

As regards its reaction behavior, said coating composition may be a composition having the reaction behavior of a one-component composition (1k), with, in this case, the crosslinking agent being a melamine or a blocked polyisocyanate, the reaction taking place solely after heating or, according to a second possibility, said coating composition may be a composition having the reaction behavior of a two-component composition (2k), with, in this case, the crosslinking agent being a non-blocked polyisocyanate or a carboxylic anhydride, in which case the reaction takes place after mixing with said crosslinking agent (i.e. immediately after this mixing). In place of the phrase “the composition has the reaction behavior of a one-component composition (1k)”, the phrase “the composition has one-component (1k) behavior” or “the composition is of one-component type” may be used with the same meaning. By analogy, this use of equivalent phrases is also valid for the phrase concerning “the composition has the reaction behavior of a two-component composition (2k)”.

Said coating composition according to the invention may also comprise other additives chosen from: rheology agents, thickeners, surface agents, dyes, catalysts, biocidal agents and antifoams, dispersants and coalescers.

Another subject of the invention relates to the use of the resin as defined above according to the invention in metallic coating compositions with one-component or two-component behavior and having a significantly more homogeneous dispersion of the metallic pigments and a higher masking power (ISO 6504) than those of the same composition with a resin not comprising said polymer P2.

More particularly, said use relates to protective crosslinked metallic coatings for metallic or plastic substrates, in the construction and repair industry in general and preferably in the industry of the construction and repair of transportation vehicles, motor vehicles, household electrical appliances and transportation vehicle accessories.

Finally, the invention also covers a metallic coating which is obtained from the use of a resin as defined above or of a coating composition as defined above according to the invention. In particular, said metallic coating is a metallic paint coating, with an aluminum pigment as metallic pigment. Even more particularly, said metallic coating is crosslinked.

The following examples are given by way of illustration of the invention and of its performance qualities and do not limit its scope, said scope being defined by the claims.

### EXPERIMENTAL SECTION

### 1) Starting Materials Used for Synthesis and Application Formulations

See Table 1 below.

### Starting Materials Used

TABLE 1

| Commercial | | | Technical |
|---|---|---|---|
| ref. | Chemical name | Supplier | function |
| SYNAQUA ® | Hydroxylated and | ARKEMA | Polymer P1 |
| E21011 | carboxylated acrylic | | |
| | polymer dispersion | | |
| ENCOR ® | Self-crosslinkable | ARKEMA | Polymer P2 |
| 2171 | hydroxylated acrylic | | |
| | emulsion | | |
| CYMEL ® | Methylated melamine | ALLNEX | Crosslinking |
| 303 LF | with a low form- | | agent |
| | aldehyde content | | |
| TOLONATE ® | Blocked aliphatic | VENCOREX | Crosslinking |
| D2 | polyisocyanate | | agent |
| STAPA IL | Aluminum pigment | ECKART | Pigment |
| HYDROLAN ® | paste (weight | | aluminium |
| 8154 | percentage of Al: 60) | | |
| HYCRYL ® | Associative thickener | ARKEMA | Thickener |
| 0210 | | | |
| DISPERBYK ® | Block polymer | BYK | Wetting |
| 190 | dispersant | | dispersant |

The characteristics of the polymers P1 and P2 used as components of the resin according to the invention are featured in table 2 below.

Summary of the characteristics of P1 (SYNAQUA E21011) and P2 (ENCOR 2171)

TABLE 2

| | | | | | Solids | |
|---|---|---|---|---|---|---|
| | | OH/resin | Carboxyl | Acetoxy/ | content | Tg |
| Ref. | Mn | (weight %) | (mg KOH/g) | diacetone | (%) | (° C.) |
| SYNAQUA ® | >2000 | 3 | 18 | no | 45 | 20 |
| E21011 (P1) | and <10000 | | | | | |
| ENCOR ® 2171 | >500000 | 1.3 | 12 | yes | 43 | 35 |
| (P2) | | | | | | |

### 3) Preparation of the Metallic Paint Formulations

The overall characteristics of the four formulations tested are given in table 3 below.

### Overall Characteristics

TABLE 3

| | Ref. | | | |
|---|---|---|---|---|
| Characteristic | 1 | 2 | 3 | 4 |
| Invention/ | inven- | compar- | inven- | compar- |
| comparative | tion | ative | tion | ative |
| P1/P2 ratio (by | 80/20 | 100/0 | 80/20 | 100/0 |
| dry weight) | | | | |
| Crosslinking | Melamine | Melamine | Polyisocyanate | Polyisocyanate |
| agent | (Cymel ® | (Cymel ® | (Tolonate ® | (Tolonate ® |
| | 303 LF) | 303 LF) | D2) | D2) |
| Ratio P1 + | 80/20 | 80/20 | — | — |
| P2/melamine | | | | |
| (by dry weight) | | | | |
| NCO/OH mole | — | — | 1.32 | 1.32 |
| ratio | | | | |
| Pigment/binder | 0.20 | 0.20 | 0.20 | 0.20 |
| ratio | | | | |
| Calculated dry | 20.6 | 20.6 | 20.6 | 20.6 |
| extract % | | | | |
| Calculated | 15.6 | 15.6 | 15.6 | 15.6 |
| GC % | | | | |
| pH (ISO 976) | 7.8 | 7.7 | 7.6 | 7.7 |

Procedure for preparing the metallic paint formulations: in the order indicated according to the following steps A) to E), add compositions 1 to 4 of table 4 below:
A) Add composition 1 and homogenize for 30 min
B) Add composition 2 to composition 1 and homogenize for 15 min
C) Premix composition 3 and then add it to 1+2 and homogenize for 10 min
D) Premix composition 4 and add it to 1+2+3 and then homogenize for 10 min
E) Add composition 5 to 1+2+3+4 and stir for 5 min
F) Add by dispersing components 6, 7, 8 and 9 in the order indicated

### Detailed Formulations of Metallic Paints (Weight %)

TABLE 4

| | | References | | | |
|---|---|---|---|---|---|
| Composition | Component | 1 | 2 | 3 | 4 |
| 1 | STAPA IL HYDROLAN ® | 5.4 | 5.4 | 5.5 | 5.5 |
| | 8154 | | | | |
| | DISPERBYK ® 190 | 0.6 | 0.6 | 0.6 | 0.6 |
| | Butyl glycol | 5.0 | 5.0 | 5.0 | 5.0 |
| | Dimethyl sulfoxide | 1.7 | 1.7 | 1.7 | 1.7 |
| 2 | Dimethylethanolamine/20% | 1.1 | 1.1 | 1.1 | 1.1 |
| | HYCRYL ® 0210/10% | 4.4 | 4.4 | 4.4 | 4.4 |
| | Demineralized water | 5.1 | 5.1 | 5.1 | 5.1 |
| 3 | ENCOR ® 2171 | 5.3 | | 4.7 | |
| | Demineralized water | 17.2 | | 17.2 | 17.3 |
| 4 | SYNAQUA ® E21011 | 23.7 | 28.3 | 18.0 | 21.5 |
| | CYMEL ® 303 LF | 3.3 | 3.3 | | |
| | TOLONATE ® D2 | | | 7.9 | 8.5 |
| | Demineralized water | | 17.2 | | |
| 5 | HYCRYL ® 0210/10% | 5.0 | 5.0 | 5.0 | 5.0 |
| 6 | Dimethylethanolamine/20% | 0.3 | 0.3 | 0.3 | 0.3 |
| 7 | Demineralized water | 8.0 | 8.1 | 8.1 | 8.1 |
| 8 | n-Butanol | 0.8 | 0.8 | 0.8 | 0.8 |
| 9 | Demineralized water | 13.1 | 13.3 | 14.5 | 15.2 |
| | TOTAL | 100.0 | 100.0 | 100.0 | 100.0 |

### 4) Application Tests and Conditions

Description of the tests and methods used:

### Conditions for Applying the Metallic Paint Formulation

Bar coater 100 μm
Wet film thickness 100 μm
Test specimens of tinplate type 250*125*0.3 mm (L*I*thickness), type TC100 (Espan Color)

### Drying

10 min flash at room temperature (23° C.±2° C., RH 50±5%)
Baking for 20 min at 140° C.

### Measurements

Masking power according to the standard ISO 6504 (Minolta CM2600D spectrophotometer)
Gloss at angles of 20°, 60° and 85° (Micro tri gloss glossmeter—Byk/Gardner) in gloss units (gu) according to the standard ISO 2813.

### 5) Application Results

Results presented in table 5 below concerning the masking power of the paint.

Results of measurement of the masking power (ISO 6504) on test formulations 1 to 4

TABLE 5

| Formulation ref. | 1 | 2 | 3 | 4 |
|---|---|---|---|---|
| Dry thickness in μm | 17 ± 2 | 17 ± 2 | 18 ± 2 | 15 ± 2 |
| (ISO 2808) | | | | |
| Masking power (ISO | 99.7 | 95.9 | 99.6 | 95.4 |
| 6504) | | | | |

The gloss results are presented in table 6 below.

### Gloss Results (ISO 2813)

TABLE 6

Formulation ref.

| Background | Angle | 1 | 2 | 3 | 4 |
|---|---|---|---|---|---|
| White | 20° | 27 | 13 | 28 | 5 |
| | 60° | 77 | 50 | 78 | 18 |
| | 85° | 84 | 69 | 85 | 21 |
| Black | 20° | 24 | 13 | 25 | 4 |
| | 60° | 74 | 49 | 75 | 17 |
| | 85° | 82 | 66 | 83 | 20 |

1. An organic binder resin for aqueous coatings comprising:
a) a polymer P1, bearing reactive groups X1: hydroxyl and Y1: carboxyl with, respectively, an OH number expressed as weight percentage of OH ranging from 2% to 5%, and an acid number IA expressed in mg KOH/g of at least 10, and said polymer P1 having a number-average molecular mass Mn1 (by GPC in THF with polystyrene calibration) of less than 25 000,
b) a polymer P2 bearing reactive groups X2: hydroxyl with an OH number expressed as weight percentage of OH ranging from 0.5% to 2.5%, groups Y2: carboxyl corresponding to an acid number IA expressed in mg KOH/g<25, and groups Z2 chosen from acetoxy and/or diacetone and said polymer P2 having a number-average molecular mass Mn2 of greater than 500,000.

2. The resin as claimed in claim 1, wherein the weight ratio between the polymer P1 and the polymer P2, P1/P2, ranges from 50/50 to 95/5.

3. The resin as claimed in claim 1, wherein said resin is in dispersion in water with a content of solids P1+P2 ranging from 30% to 60%.

4. The resin as claimed in claim 1 wherein said polymer P2 comprises a crosslinking agent bearing at least two hydrazide groups.

5. The resin as claimed in claim 1 wherein said resin is in the form of a mixture of respective aqueous dispersions of the polymers P1 and P2.

6. The resin as claimed in claim 1 wherein said polymer P1 is in the form of an aqueous dispersion without any surfactant or dispersant, having a mean particle size ranging from 50 to 250 nm according to the method ISO 13320.

7. The resin as claimed in claim 1 wherein said polymer P2 is in the form of an aqueous dispersion comprising a surfactant selected from surfactants simultaneously comprising a nonionic structure and an anionic group.

8. The resin as claimed in claim 1 wherein said polymer P1 and said polymer P2 have respective glass transition temperatures Tg1 and Tg2, measured by DSC (10° C./min, two passes), as follows:
Tg1 less than or equal to 30° C.,
Tg2 greater than 30° C.

9. The resin as claimed in claim 1 wherein said polymer P1 and/or said polymer P2 are respective binary mixtures of two copolymers, one of which is more hydrophilic.

10. The resin as claimed in claim 1 wherein said polymer P1 is in the form of a post-dispersion of said polymer after its preparation by solution radical polymerization in organic solvent medium, said polymer being dispersible in aqueous post-dispersion and not comprising any dispersant or surfactant.

11. The resin as claimed in claim 1 wherein said polymer P1 comprises an acrylic copolymer or a styrene-acrylic polymer.

12. The resin as claimed in claim 1 wherein said polymer P1 is a copolymer containing, as monomer units starting with a following overall monomer mixture:
a1) at least one C₂-C₄ hydroxyalkyl (meth)acrylate,
a2) at least one C₁-C₂ alkyl methacrylate,
a3) at least one C₄-C₈ alkyl acrylate,
a4) at least one C₁₀-C₁₄ alkyl (meth)acrylate monomer,
a5) (meth)acrylic acid, and
a6) optionally, at least one vinylaromatic monomer.

13. The resin as claimed in claim 1 wherein said polymer P2 is a copolymer in aqueous dispersion obtained by emulsion polymerization.

14. The resin as claimed in claim 1 wherein said polymer P2 is a copolymer containing, as monomer units starting with a following monomer mixture:
b1) at least one C₂-C₄ hydroxyalkyl (meth)acrylate,
b2) at least one C₁-C₂ alkyl methacrylate,
b3) at least one C₄-C₈ alkyl methacrylate,
b4) (meth)acrylic acid,
b5) at least one from among the following monomers: diacetone acrylamide and/or one from among (meth)acrylate bearing at least one acetoacetate group, and
b6) at least one di(meth)acrylate of a C₄-C₈ diol.

15. A process for preparing a resin as claimed in claim 1, said process comprising the following steps:
i) preparing polymer P1 as defined in claim 1, comprising solution radical polymerization followed by post-emulsification in aqueous medium to give rise to an aqueous dispersion of said polymer P1,
ii) preparing by emulsion polymerization of an aqueous dispersion of polymer P2, as defined in claim 1, and
iii) mixing of said aqueous dispersion of said polymer P1 with that of said polymer P2.

16. A coating composition comprising at least one organic binder resin as defined in claim 1.

17. The coating composition as claimed in claim 16, which is a metallic coating composition comprising, in addition to said organic binder resin (P1+P2), at least one metallic pigment with a content of said pigment relative to said dry organic binder (solids) ranging from 15% to 40% by weight.

18. The coating composition as claimed in claim 16, which is an aqueous metallic coating composition with a content of solids P1+P2 ranging from 5% to 30% relative to the weight of said composition.

19. The composition as claimed in claim 16 wherein said metallic pigment is selected from the group consisting of aluminum and copper pigments in the form of flakes.

20. The composition as claimed in claim 16 which is a metallic paint.

21. The composition as claimed in claim 16 which is an aqueous metallic paint with an aluminum pigment as metallic pigment.

22. The composition as claimed in claim 16 further comprising at least one crosslinking agent that is reactive with the hydroxyl groups of said polymer P1 and P2 and selected from the group consisting of melamines, polyisocyanates and carboxylic anhydrides.

23. The coating composition as claimed in claim 16 which is a composition having the reaction behavior of a one-component composition (1k), with, in this case, the crosslinking agent being a melamine or a blocked polyisocyanate, the reaction taking place solely after heating or, according to a second possibility, said coating composition is a composition having the reaction behavior of a two-component composition (2k), with, in this case, the crosslinking agent being a non-blocked polyisocyanate or a carboxylic anhydride, in which case the reaction takes place after mixing with said crosslinking agent.

24. (canceled)

25. (canceled)

26. (canceled)

27. (canceled)

28. (canceled)
